(19) United States
(12) Patent Application Publication
(10) Pub. No.: US 2009/0074655 A1
(43) Pub. Date: Mar. 19, 2009

(54) Nanoparticles, and a Method of Sol-Gel Processing

(76) Inventor: Crina Silvia Suciu, Bergen (NO)

Correspondence Address: ABELMAN, FRAYNE & SCHWAB, 666 THIRD AVENUE, 10TH FLOOR, NEW YORK, NY, 10017, US

(21) Appl. No.: 12/085,974

(22) PCT Filed: Dec. 1, 2006
(86) PCT No.: PCT/NO2006/000454

§ 371 Date: Oct. 24, 2008

(30) Foreign Application Priority Data
Dec. 2, 2005 (NO) 20055721

(51) Int. Cl. C01G 25/02; C01B 33/141; B01J 13/00

(52) U.S. Cl. 423/608; 516/111; 516/98; 516/112

(57) ABSTRACT

Methods of sol-gel processing for preparing of gels and nanoparticles are described. The invention also relates to gels and nanoparticles prepared by the described methods. A preferable embodiment describes ZrO₂ nanoparticles produced by sol gel processing by using sucrose and pectin as polymerization agents.

### FIELD OF INVENTION

The present invention relates to a method of sol-gel processing for preparing of a gel and nanoparticles, and also gels and nanoparticles produced by said methods.

### BACKGROUND OF THE INVENTION

The interest for nanostructured materials, which are synthesised from particles smaller than 100 nanometers, has been growing in the last decades. The interest has been stimulated by the large variety of applications in industries such as aerospace, steel, cosmetics, health, automotive, bioengineering, optoelectronics, computers, and electronics. Research to develop applications have resulted in technologies that make it possible to obtain multilayered films, porous pillars, thin films, nanocrystalline materials, nanopowders and clusters for e.g. paints, antiseptics, nanocomposites, drugs, biomedical implants and military components.

It is very well known that materials with nanoscale grain size show different properties from the same material in bulk form. These unique properties are related to the large number of surface or interface atoms. Nanostructured materials have good refractory properties, good chemical resistance, good mechanical resistance and hardness both at normal and high temperatures; they are especially amenable to sintering and reactions with different oxides. It has also been shown that the large number of surface atoms present in these materials influences the optical, electrical and magnetic properties.

It is now well recognized that the mechanical, electrical, chemical as well as catalytic properties of zirconia can be improved by using nanopowders instead of conventional micron-sized zirconia. When synthesizing of conventional Zr based materials the medium size of the particles is normally in the region of 10 microns, which is generally equivalent to 10¹⁵ atoms. Particles with diameters ranging between 0.1 and 1 micrometer are considered fine particles and are usually made up of 10⁹-10¹⁰ atoms. Particles on a nano-scale, with dimensions ranging from 1 to 100 nanometers (nm) in at least one direction are of particular interest. Particles consisting of 200-300 atoms are designated clusters and their surface atoms can represent up to 80-90% of the total number of the atoms in the particle.

Over the past several years, a number of techniques have been developed for the production of ceramic nanoparticles and include: laser ablation, microwave plasma synthesis, spray pyrolysis, plasma arc synthesis, hydrodynamic cavitation and gas condensation using either a physical evaporation source or chemical precursors. Yet other methods of obtaining nanoparticles have been used, such as wire explosion techniques [1], the polymerizable complex method [2], flame synthesis of nanoparticles [3], the sonochemical method [4], solid state reaction [5], precipitation [6] and co-precipitation from a solution, and sol-gel synthesis.

The sol-gel method and co-precipitation from solutions form, together with oxidation-reduction reactions, hydrolysis, colloidal processes, and pyrolysis of organic-metallic complex substances, the chemical methods category [7]. Chemical methods have an important place among the experimental methods applied on pilot scale. This is so-called “soft chemistry” which uses relatively non-aggressive diluted solutions at moderate temperatures. The intense research and development work in this field has led to the availability of chemically pure, nano-sized powders with a narrow size distribution. These materials are valuable, but difficult to handle and are prone to agglomeration when using conventional processing routes.

At present, the most important chemical methods of obtaining nanopowders are the Pechini method, the co-precipitation method and the GN method. Keiji Yamahara, et al [8], used all three methods to obtain 8YSZ (ZrO₂ doped with 8 mol % Y₂O₃). In the Pechini method the zirconium salt (ZrO(NO₃) xH₂O) is dissolved in distilled water after which citric acid (CA-C₆H₈O₇) and ethylene glycol (EG-C₂H₆O₂) are added to the solution. In the co-precipitation method a solution of 30% ammonium hydroxide is added dropwise to zirconium salt dissolved in water. In the GN method, glycerin C₃H₈O₃ is added to a zirconium salt solution. Ch. Laberty-Robert obtained nanocrystallite powders of YSZ using the Pechini method using zirconium chloride and yttrium nitrate as precursors and ethylene glycol and citric acid as polymerization agents [7].

A method for obtaining nanoparticles that does not need expensive equipment is the sol-gel route. The sol-gel method is based on molecular synthesis of nanoparticles wherein the particles are built up by molecule-by-molecule addition. During the process of nanopowder formation close control over the nucleation and growth of the particles is required because the particles easily adhere and form agglomerates.

### SUMMARY OF THE INVENTION

The present invention is directed to methods for sol-gel processing using inorganic metal salts.

The present invention is also related to methods for producing nanosize particles from inorganic metal salts.

The present invention is also directed to particles, sols and gels produced according to methods described herein.

The methods generally involve mixing together an inorganic metal salt, water and a mono or disaccharide. The macromolecular dispersant molecule pectin is also added. The resulting homogenous solution is dried at elevated temperature until it becomes completely gelatinized. Further thermal treatment of the dried gel will transform the material to nano-particles.

Several parameters of the method can be manipulated, making the method highly tunable, and enabling production of sols, gels and particles with various desired characteristics. Variables that can be controlled and which control the product characteristics include the choice of metal salts, the metal salt concentration, ratio of mono or disaccharide solution to water, incubation temperature and time, and concentration of macromolecular dispersant.

### FIGURE LEGENDS

FIG. 1 is a schematic illustration of one embodiment of the invention, showing a process for the preparation of zirconium gels and particles as described in example 1.

FIG. 2 shows the result of thermal analyses of the ZrO₂ sample prepared as described in example 1.

FIG. 3 is an electron microscopy of ZrO₂ powders at 50 000 and 100 000 times magnification at 900° C.

FIG. 4 shoes X-ray diffraction of ZrO₂ powders at 900 and 1000° C.

### DETAILED DESCRIPTION OF THE INVENTION

The present invention relates to methods for production of gels and nanoparticles from inorganic metal salts. The methods offer sol-gel processing to produce a wide variety of materials of high quality.

The methods utilize homogenous nucleation and growth phenomena in inorganic solutions of mixed solvents, such as a mixed solvent of water and mono or disaccharides

The methods are applicable for production of sols, gels and nanoparticles from many metals such as aluminum, hafnium, silicon, zirconium, titanium, lanthanum, germanium, and tantalum, among others, by means of inorganic salts, e.g. nitrates, sulfates, sulfides, and chlorides of the same elements. Combinations of metals and salts can also be used. The concentration of the metal salt can range from about 0.005 M to about 0.5 M, more preferably from about 0.025 M to 0.02 M.

Preferred metals include zirconium and nickel, and the preferred salts used are ZrCl₄, ZrO(NO)₃xH₂O, ZrOCl₂x8H₂O, and NiCO₃, Ni(COOH)₂, Ni(NO)₃.6H₂O, NiSO₄.7H₂O.

Organic compounds that can be used include mono and disaccharides, such as fructose and glucose, and sucrose.

The present invention uses pectin in addition to mono and disaccharides as polymerization agents. Pectin can be added either before or after the incubation.

Neutralizing and/or stabilizing agents can be used to stabilize the formed particles. Ammonia can for instance be used for chemical stabilization of oxide particles.

A first aspect of the present invention is thus related to a method of sol-gel processing, wherein an inorganic metal salt, pectin, and mono or disaccharides are used, and that said method comprises the steps:

a) preparing a first aqueous solution comprising said inorganic metal salt, and preparing a second aqueous solution comprising said mono or disaccharides
b) mixing the first and second solutions to a third solution at a temperature from about 80 to 100° C.,
c) incubating the combined solution from step b) at an elevated temperature of about 80 to 200° C. in order to gelatinize the third solution to a gel material.

A second aspect of the invention relates to a method of sol-gel processing, wherein an inorganic metal salt, pectin and mono or disaccharides are used, and that said method comprises the steps:

a) preparing a first aqueous solution comprising said inorganic metal salt, and preparing a second aqueous solution comprising said mono or disaccharides,
b) mixing the first and second solutions to a third solution at a temperature from about 80 to 100° C.,
c) incubating the combined solution from step b) at an elevated temperature of about 80 to 200° C. in order to gelatinize the third solution to a gel material,
d) thermal treatment of the gelatinized material from step c) at a temperature of from 500 to 1200° C., preferable from 700 to 1000° C.

Further aspects of the invention relates to gels and nanoparticles prepared by the methods indicated above.

A preferred embodiment relates to ZrO₂ nanoparticles produced by sol-gel processing by using sucrose and pectin as polymerization agents, wherein the nanoparticles, after thermal treatment at 900° C. are in the tetragonal phase with crystallite size of 50 nm and particle size less than 90 nm.

A more preferred embodiment relates to ZrO₂ nanoparticles produced by sol-gel processing by using sucrose and pectin as polymerization agents, wherein the nanoparticles, after thermal treatment at 900° C. are in the tetragonal phase with crystallite size of 30 nm and particle size less than 35 nm

Preferred embodiments of the invention relates to sol-gel processing wherein the metal salt contains a metal selected from the group consisting of aluminium, hafnium, silicon, zirconium, lanthanum, germanium, tantalum, nickel, combinations thereof, and combinations thereof with titanium.

Currently preferred methods use metal salt containing zirconium or nickel.

Preferable, the solution of mono or disaccharides contains a compound selected from the group comprising sucrose, maltose, lactose, fructose and glucose, and most preferable the compound is sucrose.

The invention is further illustrated by the following example, which is not to be construed in any way as imposing limitations upon the scope of the invention. On the contrary, it is to be clearly understood that resort may be had to various other embodiments, modifications, and equivalents thereof, which, after reading the description herein, may suggest themselves to those skilled in the art without departing from the spirit of the present invention.

### EXPERIMENTAL SECTION

### Example 1

### Preparation of Zirconium Based Sols and Nanoparticles by Using Sucrose and Pectin as Precursor

Traditionally organic precursors used in the “chemical methods” referred to above are glycerol in the GN method, and ethylene glycol and citric acid in the Pechini method. The inventors of the present invention have surprisingly found that other precursor molecules can be used to obtain the gels and nanoparticles.

Convincing results have been obtained by using sucrose and pectin as precursor molecules. Pectin can be regarded as a dispersing agent, and we have also shown that the weight ration of sucrose to pectin will influence the gelatinization process.

Sucrose, C₆H₁₂O₆, consists of one molecule of glucose and one molecule of fructose. C₆H₁₂O₆ is the chemical formula for both glucose and fructose, but they have slightly different structures. Table sugar is nearly pure sucrose (around 99% sucrose).

Pectin is present in ripe fruits and some vegetables. Pectin consists of a linear polysaccharide containing between 300 and 1,000 monosaccharide units.

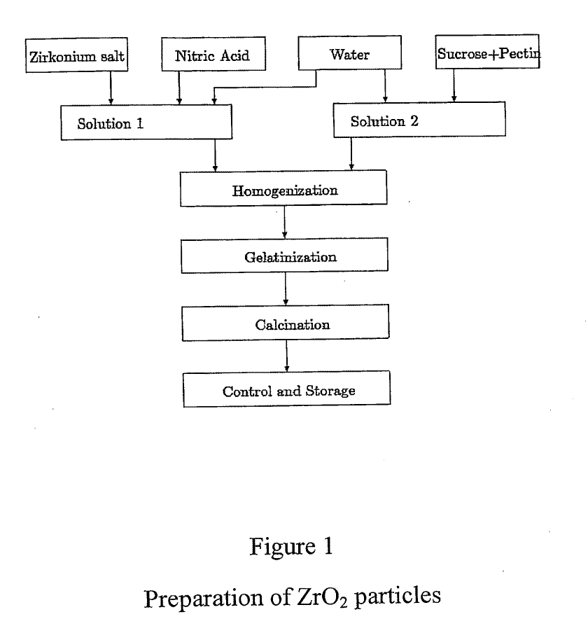

We followed the reaction scheme shown in FIG. 1. Basically this method requires as raw materials either esters or salts soluble in weakly acidic organic solutions. As source of zirconium we used zirconium nitrate, Zr(NO₃)₄.5H₂O, a frequently used inorganic salt in sol-gel methods. The zirconium salt dissolves in water acidified with nitric acid with pH 4.5, forming a transparent solution at normal temperature (we call this solution 1 or first solution). Sucrose and pectin are dissolved into large quantities of water at a water:material ratio of 10:1 up to 15:1, thus obtaining another transparent liquid (this solution is termed “solution 2” or the second solution).

Next the two solutions are mixed by slowly pouring solution 1 into solution 2 under moderate continuous stirring in order to disperse the suspension. The aim of the subsequent, described below, treatment is to maintain the degree of dispersion on an advanced scale, to prevent agglomeration of the constituent particles and to avoid their solidification into crystals or raw granular formations during the different stages of the processing.

The solution is dried at 90-100° C. and is allowed to stand for 48 hours, until it becomes completely gelatinized. Some NOx gases are emitted during this drying step. The dried gel, which takes the appearance of a brown resin, is then subjected to thermal treatment in order to be transformed into zirconia nanoparticles. We used 700, 900, and 1000° C. During heating, smoke and gases are emitted up to 500-600° C. due to combustion of the organic component and of the nitric acid. A special oven with ventilation is therefore required.

We have performed several experiments with a view to studying the influence of the following factors:
The concentration of zirconium salt (precursor salt) in solution 1;
The mixing temperature of the liquids and the necessity of stirring during mixing and homogenization;
The temperature and duration of gelatinization;
The thermal treatment required to transform the precursor into oxide powder.

We found that the most favorable conditions for processing are the following:
The concentration of the zirconium salt should be lower than 20 g/l;
The mixing of the two solutions should be done by dripping in the organic constituent while continuously stirring;
After mixing and homogenization, stirring of the mixture should continue for 4 hours;
The gelatinization temperature should be 90° C.;
In order to transform the mixture into dioxide the thermal treatment should be performed at a temperature between 700 and 1000° C.

The obtained powders were investigated by thermal analysis (Derivatograph Q 1500), BET analysis (Gemini 2380), TEM microscopy (JEOL-JEM-100S Electron Microscope), X-ray diffraction (Brucker-Nonius D8-System) using Cu-Kα The medium size of the particles was determined from X-ray diffraction line broadening using the Scherrer formula.

### Results

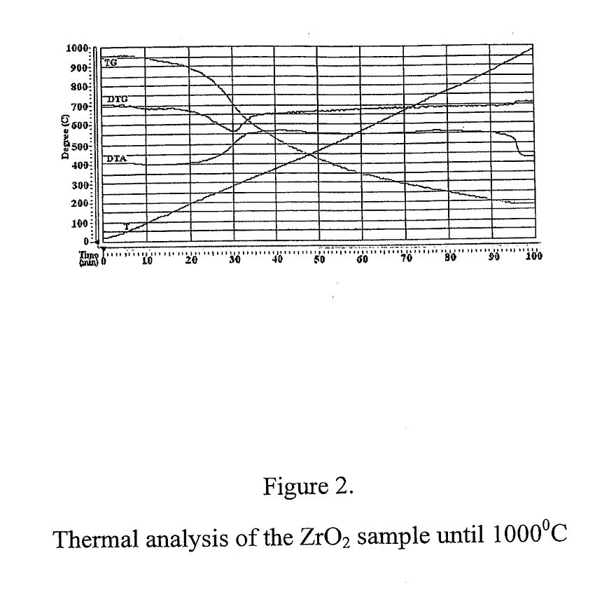

The thermal analysis (TA) were used to determine the chemical and physical properties of the samples as a function of temperature or time based on the thermal effects that occur during heating or cooling (see FIG. 2). The thermal analyses were performed on dried ZrO₂ gel using a Derivatograph Q 1500 (MOM Hungary) instrument which is based on the F. Pauli, J. Pauli and L. Erdey system.

Analyzing the TG and TDG curves of the ZrO₂ samples a 10% mass reduction occurs between 100 and 200° C. which can be due to elimination of the water residue. Between 200 and 350° C. a 30% mass reduction occurs due to the decomposition and evaporation of organic components. The mass reduction continues slowly until 950° C. and then the mass remains constant. The total loss is 82% of the initial mass.

Comparing the two above-mentioned curves with the DTA curve it can be observed that an exothermic process occurs at 200° C. due to the oxidation of the organic components. The resulting gaseous reaction products are the cause of the mass reduction. The exothermic process continues with relatively constant intensity until 950° C., although the mass reduction is not so important in this interval. This can be explained if we assume the existence of another exothermic process, which takes place simultaneously with the oxidation of the organic components. This process might be the formation of ZrO₂ through oxidation. After passing the temperature of 950° C. no processes can be observed either on the mass variation curves (TG) or on the DTA curve.

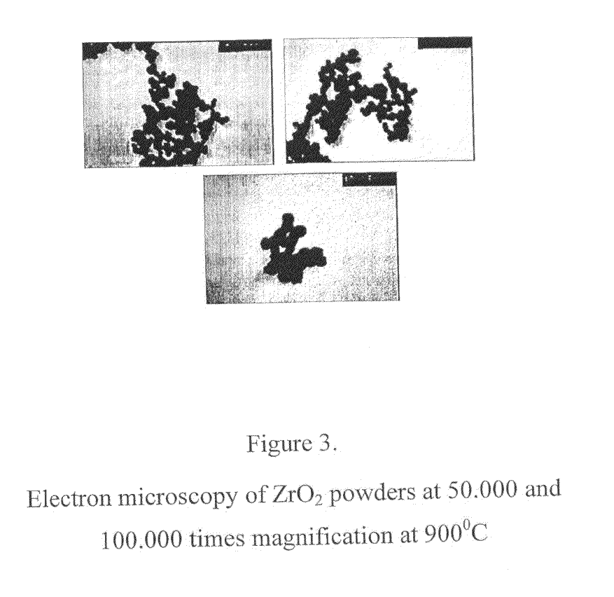

The morphology of the obtained powders was investigated using Transmission Electron Microscopy (TEM) performed by a JEOL-JEM-100S Electron Microscope. At magnifications of 50.000 times the TEM analysis showed extremely small, clustered particles. The morphology of the particles could be visualized at 100.000 times magnification (see FIG. 3). We notice distinct particles with fairly uniform dimensions ranging from 50 to 90 nanometers.

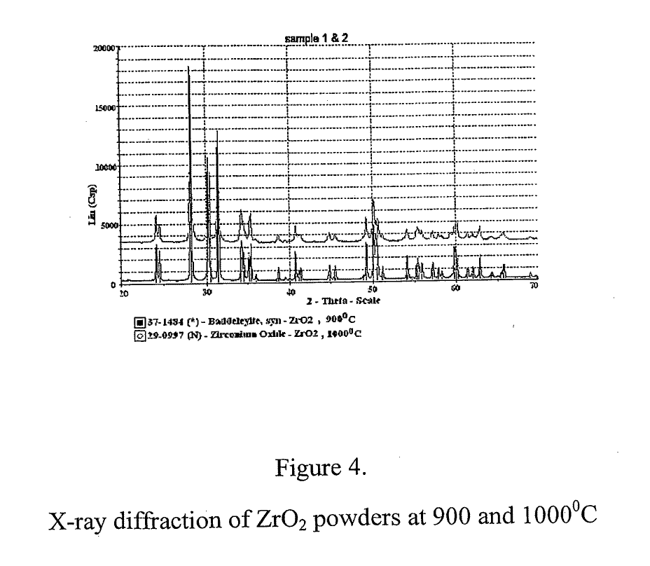

The X-ray diffraction data, determined by Brucker-Nonius D8-System, are shown in FIG. 4. The reflections characteristic of baddeleyite (ZrO₂) are presents at 900° C. and monoclinic zirconium oxide (ZrO₂) at 1000° C. The effect of increasing the temperature of the thermal treatment is to obtain a higher degree of crystallinity forming monoclinic, rather than amorphous, zirconia. The X-ray diffraction spectra were used also for determining the mean size of the particles. For calculation of the mean particle size (D) the Scherrer formula has been used:

$$D = \frac{k λ}{B cos θ}$$

where:
k—is a constant equal to unity;
λ=0.15406 nm, the wavelength of CuI(alpha1;
B—is the Integral Breadth (radians), corrected for instrumental broadening;
θ—is the top position (1.4.5 deg used for all lines).

We found that the mean particle size is 53 nm in the case of the sample heat treated at 900° C., while for the sample heat-treated at 1000° C. the size of the particles was 102 (see table 1).

TABLE 1
The medium size of the particles for the samples at 900
find 1000° C.

| | | | | | I.Breadth (B) | |
|---|---|---|---|---|---|---|
| | Obs. | | | | meas. minus | |
| | Max | d(obs. | FWHM | I.Breadth | ref. | mean |
| | 2-Theta | Max) | 2-Theta | 2-Theta | 2-Theta | size |
| | (deg.) | Å | (deg.) | (deg.) | (deg.) | (nm) |
| sample 1 | 28.245 | 3.15707 | 0.195 | 0.255 | 0.172 | 53 |
| sample 2 | 28.230 | 3.15869 | 0.141 | 0.172 | 0.089 | 102 |

The specific surface area of the samples was also determined by nitrogen adsorption according to the BET adsorption isotherm. The apparatus used was a Gemini 2380 from Micromeritics. A single point analysis gave 11.85 m²/g, and a multipoint analysis 12.52 m²/g, both with very good reproducibility. Using a density for ZrO₂ of 5600 kg/m³ and assuming the particles to be round, this would correspond to particle diameters of 90.4 and 85.9 nm, respectively. This agrees roughly with the results from the XRD above. It must be said, however, that there are clearly necks between the particles shown in FIG. 3, something that would tend to reduce the specific surface area relatively to that expected from loose particles.

### CONCLUSIONS

We shown have that it is possible to produce fine-grained zirconium oxide using sucrose and pectin as polymerization agents in relatively simple conditions and at low costs. We have also produced NiO particles with the same precursors/polymerization agents (data not shown).

The particles have practically uniform dimensions and distinct forms, they do not easily adhere to each other and their dimensions are lower than 100 nanometers.

The process takes 60 hours at most, and preferable the time to obtain a batch of nanoparticles is between 20 and 30 hours depending on the burning temperature and heating rate. This is an improvement compared to other chemical processes described in the literature.

### REFERENCES

[1] V. Giri Sabari, R. Sarathi, S. R. Chakravarthy, and Venkataseshaiah. Studies of production and characterization of nano Al₂O₃ powder using wire explosion technique. Materials Letters, 58:1947-1050, 2004.
[2] M. Popa and M. Kakihana. Ultrafine niobate ceramic powders in the system RExLil-xNbO3 (RE: La, Pr, Sm, Er) synthesized by polymerizable complex method. Catalysis Today, 78:519-527, 2003.
[3] A. Singhal, G. Skandan, A. Wang, N. Glumac, and B. H. Kear. Minimizing aggregation effects in flame synthesized nanoparticles. Scripta Materialia, 44:2203-2207, 2001.
[4] J. Liang, X. Jiang, G. Liu, Z. Deng, J. Zhuang, F. Li, and Y. Li. Characterization and synthesis of pure ZrO2 nanopowders via sonochemical method. Mater. Res. Bull., 38:161-168, 2003.
[5] A. Udompom and S. Ananta. The phase formation of lead titanate powders prepared by solid-state reaction. Current Applied Physics, 4:186-188, 2004.
[6] C. Y. Tai, M. H. Lee, and Y. C. Wu. Control of zirconia particle size by using two emulsion precipitation technique. Chem. Eng. Sci., 56:2389-2398, 2001.
[7] Ch. Laberty-Robert, F. Ansart, C. Deloget, M. Gaudon, and A. Rousset. Powder synthesis of nanocrystalline ZrO2-8% Y2O3 via a polymerization route. Mater. Res Bull., 36:2083-2101, 2001.
[8] K. Yamahara, P. C. Jacobson, J. S. Visco, and L. C. De Jonghe. Influence of powders on ionic conductivity of polycrystalline zirconias. In Solid Oxide Fuel Cells VIII, Electrochemical Society Proceedings, volume 2003-7, pages 187-195, 2003.

1.-42. (canceled)

43. A method of sol-gel processing, characterized in that an inorganic metal salt, pectin and mono or disaccharides are used, and that said method comprises the steps:
a) preparing a first aqueous solution comprising said inorganic metal salt, and preparing a second aqueous solution comprising said mono or disaccharides;
b) mixing the first and second solutions to a third solution at a temperature from about 80 to 100° C.;
c) incubating the combined solution from step b) at an elevated temperature of about 80 to 200° C. in order to gelatinize the third solution to a gel material.

44. The method according to claim 43, wherein the metal salt contains a metal selected from the group consisting of aluminium, hafnium, silicon, zirconium, lanthanum, germanium, tantalum, nickel, combinations thereof, and combinations thereof with titanium.

45. The method according to claim 43, wherein the concentration of inorganic salt in the third solution is in the range of 20 g/l to 60 g/l.

46. The method according to claim 45 wherein the concentration of inorganic salt in the third solution is 26 g/l.

47. The method according to claim 43, wherein said mono or disaccharides contains a compound selected from the group consisting of sucrose, maltose, lactose, fructose and glucose.

48. The method according to claim 43, wherein the mixing step b) is conducted by slowly pouring the first solution into the second solution in a continuous flow, and where the third solution thereafter is mixed at a rate of 120-130 rot/min.

49. A gel produced according to the method of claim 43.

50. The gel produced according to the method of claim 44.

51. The gel produced according to the method of claim 45.

52. The gel produced according to the method of claim 46.

53. The gel produced according to the method of claim 47.

54. The gel produced according to the method of claim 48.

55. A method of sol-gel processing, characterized in that an inorganic metal salt, pectin and mono or disaccharides are used, and that said method comprises the steps:
a) preparing a first aqueous solution comprising said inorganic metal salt, and preparing a second aqueous solution comprising said mono or disaccharides;
b) mixing the first and second solutions to a third solution at a temperature from about 80 to 100° C.;
c) incubating the combined solution from step b) at an elevated temperature of about 80 to 200° C. in order to gelatinize the third solution to a gel material;
d) thermal treatment of the gelatinized material from step c) at a temperature of from 500 to 1200° C.

56. The method according to claim 55, wherein the thermal treatment in step d) is conducted at a temperature of 700 to 1000° C.

57. A method in accordance with claim 55, for producing nanoparticles, wherein the nanoparticles are monodisperse.

58. A method in accordance with claim 55, for producing nanoparticles, wherein the nanoparticles are less than 100 nanometers in at least one dimension.

59. A method according to claim 55, wherein the metal salt contains a metal selected from the group consisting of aluminium, hafnium, silicon, zirconium, lanthanum, germanium, tantalum, nickel, combinations thereof, and combinations thereof with titanium.

60. A gel produced according to the method of claim 55.

61. A gel produced according to the method of claim 56.

62. A gel produced according to the method of claim 57.

63. A gel produced according to the method of claim 58.

64. A gel produced according to the method of claim 59.

65. A material in the form of nanoparticles produced according to the method of claim 55.

66. A material in the form of nanoparticles produced according to the method of claim 55.

67. A material in the form of nanoparticles produced according to the method of claim 57.

68. A material in the form of nanoparticles produced according to the method of claim 58.

69. A material in the form of nanoparticles produced according to the method of claim 59.

70. ZrO₂ nanoparticles produced by sol-gel processing by using sucrose and pectin as polymerization agents, characterized in that after thermal treatment at 900° C. the nanoparticles are in the tetragonal phase with crystallite size of 30 nm and particle size less than 35 nm.
